(19) United States
(12) Patent Application Publication
(10) Pub. No.: US 2022/0168705 A1
(43) Pub. Date: Jun. 2, 2022

(54) FORMULATION AND METHOD FOR PREPARING FIBROUS MATERIAL COMPRISING NANOFIBERS, AND FILTER COMPRISING THE FIBROUS MATERIAL

(71) Applicant: NANOSHIELDS TECHNOLOGY LIMITED, Hong Kong (HK)

(72) Inventors: Siu Wah WONG, Hong Kong (HK); Hoi Tung Danny CHAN, Hong Kong (HK); Muk Fung YUEN, Hong Kong (HK); Lok Hey WONG, Hong Kong (HK); Wai Tat NG, Hong Kong (HK); Kwun Wing HO, Hong Kong (HK); Yu Tao ZHANG, Hong Kong (HK)

(21) Appl. No.: 17/537,637

(22) Filed: Nov. 30, 2021

Related U.S. Application Data
(60) Provisional application No. 63/119,120, filed on Nov. 30, 2020.

(51) Int. Cl. B01J 20/26; B01J 20/18; B01J 20/02; B01J 20/08; B01J 20/28; B01J 20/30; B01J 29/04; B01J 35/00; A01N 25/10; A01P 1/00; A01N 43/36; A01N 43/40; A01N 33/12; A62B 23/02; B01D 39/16; C02F 1/00

(52) U.S. Cl. CPC B01J 20/262; B01D 2239/0631; B01J 20/18; B01J 20/0248; B01J 20/08; B01J 20/28023; B01J 20/3007; B01J 20/3042; B01J 29/04; B01J 35/004; A01N 25/10; A01P 1/00; A01N 43/36; A01N 43/40; A01N 33/12; A62B 23/02; B01D 39/163; C02F 1/002; C02F 1/003; B01D 2239/025; B01D 2239/0442; B01D 2239/10; B01J 20/261

(57) ABSTRACT

The present invention provides a formulation and method for preparing a fibrous material comprising nanofibers. The formulation comprises (a) at least one polymer, (b) at least one solvent in which the at least one polymer is dissolved to provide a polymer solution, and (c) at least one functional additive that imparts functionality to the fibrous material. The at least one functional additive is dissolvable or suspensible in the polymer solution. The formulation is able to remove or reduce the concentration of bacteria, viruses and heavy metals while maintaining high filtration efficiency. The invention also relates to a fibrous material prepared by the formulation and applications of the fibrous material.

### CROSS-REFERENCE OF RELATED APPLICATION

This application claims benefit of U.S. Provisional Application having Ser. No. 63/119,120 filed on Nov. 30, 2020, which is hereby incorporated by reference herein in its entirety.

### FIELD OF THE INVENTION

This invention relates to a formulation and method for preparing a fibrous material in nanoscale and/or submicron scale, which can be functionalized to exhibit one or more advantageous properties, including the ability of removing or reducing the concentration of bacteria, viruses and heavy metals while exhibiting good filterability, permeability and adsorption. The invention further relates to the fibrous material prepared by the formulation and applications of the fibrous material.

### BACKGROUND OF THE INVENTION

The importance of materials with porous structure made from fibers in the nanoscale and/or submicron scale increases rapidly due to the properties of the highly porous structure, nano-sized pore, and distribution and high specific surface area, which leads to a variety of applications in face masks, air filtration, water purification, liquid filtration, desalination, distillation, tissue engineering, protective clothing, composites, battery separators, sensors, wound dressing, highly breathable fabric, etc. Particularly, nano-sized membranes can filter out harmful particles down to nano level, for example, PM2.5 particles which can damage the human lung.

Fibers with a diameter ranging from a few tens of nanometers to a few tens of micrometers are generated for polymeric materials with porous structure. Many synthetic and fabrication methods have already been demonstrated for generating nanostructures in the form of fibers. Among these methods, electrospinning is one of the most popular and simplest approaches to manufacture high-quality ultra-thin fibers with a diameter ranging from a few tens of nanometers to a few tens of micrometers for the fabrication of polymeric materials with porous structure. Nanofibers produced from electrospinning have enormous properties such as high surface area, highly porous structure, small pore size, etc. They, therefore, can be used for various purposes including filtration. Nanofibers can tremendously improve the performance of filter media's ability to remove particulates from air streams and impurities present in water. Nanofibers could be the key elements for filtration materials in face masks and other air filtration applications, as well as water filters and other water treatment applications, due to their very high surface area per unit mass, which can enhance their capture efficiency.

Accordingly, it would be advantageous to use the nanofibers to form fibrous materials for various types of filtration applications. It would also be beneficial to include one or more functional additives in the nanofibers to enhance the antimicrobial effect, sanitizing and/or disinfecting properties of the porous fibers, and to enable the comprehensive removal of a wide range of undesirable particulates and other impurities from water.

### SUMMARY OF THE INVENTION

The present invention has a principal object of providing a formulation for use in preparation of a polymer solution for nanofibers production. The formulation comprises one or more functional additives to functionalize the polymer solution and thus the electrospun nanofibers which are provided with improved properties.

This and other objects are satisfied by a first aspect of the present invention, which provides a formulation for preparing a fibrous material comprising nanofibers, comprising the following components:

(a) at least one polymer,

(b) at least one solvent in which the at least one polymer is dissolved to provide a polymer solution, and

(c) at least one functional additive that imparts functionality to the fibrous material, wherein the at least one functional additive comprises one or more selected from the following groups (c1) to (c3):
(c1) a biocide,
(c2) a processing aid,
(c3) a barrier for physical and/or chemical contaminants,

wherein the at least one functional additive is dissolvable or suspensible in the polymer solution.

In a preferred embodiment of the invention, the components (a) to (c) add up in total to 100 wt. % of the formulation, among which components (c1), (c2) and (c3) may be present in the formulation individually or in any combination.

In certain cases of the invention, the biocide may be selected from the group consisting of povidone-iodine (PVP-I), octenidine (OCT), polybiguanides, quaternary ammonium compounds, chloroxylenol, silver nanoparticle (Ag-NP), silica nanoparticle (Si-NP), polyethyleneimines (PEI), N-halamines, zinc citrate, triclosan, polyphenol, phenylcarboxylic acid, ellagic acid, and any combination thereof. In certain cases of the invention, the biocide may be selected from the group consisting of polyhexanide (PHMB), polyaminopropyl biguanide (PAPB), ammonium chloride, benzalkonium chloride, benzododecinium chloride, benzethonium chloride, benzyltriethylammonium chloride (BTEAC), methylbenzethonium chloride, chlorhexidine salts, cetylpyridinium chloride, cetalkonium chloride, cetrimonium bromide, cetyltrimethylammonium salts, cetrimide, dofanium chloride, tetraethylammonium bromide, didecyldimethylammonium chloride, domiphen bromide, catechin polyphenols, persimmon tannin polyphenols, grape seed polyphenols, soybean polyphenols, lemon peel polyphenols, coffee polyphenols, and any combination thereof.

In certain cases of the invention, the processing aid may be hydrophilic biocompatible polymers preferably selected from the group consisting of polyethylene glycol (PEG), poly(N-isopropylacrylamide), polyacrylamide, polyethylenimine, poly(acrylic acid), poly(vinyl alcohol) (PVA), poly(vinylpyrrolidone), and any combination thereof.

In certain cases of the invention, the barrier may be selected from the group consisting of aluminum hydroxide oxide (AlO(OH)), tourmaline, tourmaline, Zeolite, photocatalyst, active carbon, and any combination thereof.

In one preferred embodiment of the invention, the formulation for preparing the nanofibers useful for an air filter comprises:

(a) 5-20 wt % of the at least one polymer,

(b) 55-95 wt. %, preferably 65-95wt. % of the at least one solvent,

(c1) 0.1-15 wt. %, preferably 0.1-10 wt. %, more preferably 0.1-5 wt. % of the biocide,

(c2) 0.1-5 wt. % of the processing aid, and

(c3) 0.1-5 wt. % of the barrier,

wherein components (a), (b), (c1) to (c3) add up in total to 100 wt. % of the formulation, and

wherein each of the functional additives (c1), (c2) and (c3) accounts for at least 0.1-5 wt. % if the formulation comprises two or more additives.

In another preferred embodiment of the invention, the formulation for preparing the nanofibers useful for a water filter comprises:

(a) 5-20 wt. % of PVDF,

(b) 55-95 wt. %, preferably 65-94.7 wt. % of DMF in which PVDF is dissolved to provide the polymer solution, and

(c1) the biocide comprising 0.1-10 wt. % of PVP-I, 0.1-5 wt. % of OCT, and 0.1-5 wt. % of BTEAC,

wherein components (a), (b) and (c1) add up in total to 100 wt. % of the formulation.

In a further preferred embodiment of the invention, the formulation comprises:

(a) 5-20 wt. % of the at least one polymer,

(b) 55-94 wt. %, preferably 65-94 wt. % of the at least one solvent, and

(c1) 0.1-15 wt. %, preferably 0.1-10 wt. %, more preferably 0.1-5 wt. % of the biocide,

(c2) 0.1-5 wt. % of the processing aid, and

(c3) 0.1-5 wt. % of the barrier,

wherein components (a), (b), (c1) to (c3) add up in total to 100 wt. % of the formulation, and

wherein each of the functional additives (c1), (c2) and (c3) accounts for at least 0.1-5 wt. % if the formulation comprises two or more additives.

In a yet preferred embodiment of the invention, the formulation comprises:

(a) 5-20 wt. % of PAN,

(b) 65-93.9 wt. % of DMF in which PAN is dissolved to provide the polymer solution,

(c1) the biocide comprising 0.1-5 wt. % of BTEAC, and

(c3) the barrier for removal of heavy metals comprising 1-10 wt. % of aluminum hydroxide oxide,

wherein components (a), (b), (c1) and (c3) add up in total to 100 wt. % of the formulation.

The fibrous material of the invention is suitable to be used as a filter medium of gas filters, gas-liquid filters or liquid-solid filters. Thus, in a second aspect, the invention provides a filter comprising a fibrous material used as the material of a filter medium of the filter, and the fibrous material is prepared by the formulation of the invention.

The fibrous material of the invention has been found to have well-distributed nanofibers with small mean diameter, high filtration efficiency and high flow rate, and may be designated for filtration of gases and liquids, especially for filtration of air and water. The accordingly fabricated filters are capable of not only removing physical and chemical contaminants but also especially filtering and killing biological contaminants.

In one embodiment of the invention, the filter is the type of face mask comprising:

an outer protective layer exposed to an external environment,

an inner layer configured to fit for covering mouth and nose of a wearer, and

at least one intermediate layer comprising the filter medium made of the fibrous material and sandwiched between the outer layer and the inner layer.

Advantageously, the outer layer, intermediate filter layer, and/or inner layer of the face mask vary hydrophilicity or hydrophobicity in a direction from the inner layer to the intermediate layer such that a moisture concentration gradient is formed between the inner layer and intermediate layer with the inner layer having the least moisture and the intermediate layer having the most moisture when the face mask is worn.

In another embodiment of the invention, the filter is the type of water filter adapted for portable and home water filtration systems.

According to a third aspect of the invention, a method for preparing a fibrous material comprising nanofibers, comprising the steps of:

a) providing a polymer solution formulated by the formulation according to the invention,

b) providing one or more collection electrodes and one or more spinning electrodes between which a substrate passes through,

c) applying a voltage across the one or more collection electrodes and the one or more spinning electrodes to generate an electrostatic field which induces an electrospinning zone between the collection and spinning electrodes, and

d) supplying the polymer solution to the one or more spinning electrodes to be drawn into nanofibers from each of the spinning electrodes in the electrospinning zone for deposition of the nanofibers onto the substrate.

The method of the invention may further comprise the step of applying a binder into the polymer solution before the polymer solution is supplied to the spinning electrodes, or applying a binder in a form of aqueous dispersion onto the substrate on which the nanofibers are deposited.

In one embodiment of the invention, the method may comprise the step of loading the polymer solutions of same type or different types, which are imparted same or different functionalities, for electrospinning thereby to deposit same type or different types of nanofiber contents onto the substrate.

In another embodiment, the method may comprise the step of interlacing the nanofibers of different natures to form a fiber layer having an interlaced structure with a greater flexibility.

### DETAILED DESCRIPTION OF THE PREFERRED EMBODIMENTS

The disclosed invention is primarily concerned with the development of formulations for nanofibers production. The nanofibers include one or more functional additives to provide improved properties of the nanofibers, including removal or reduction in various types of contaminants, e.g., those hard-to-remove heavy metals, bacteria and viruses, volatile organic compounds (VOCs). The nanofibers have multiple applications and are particularly suitable for the production of filtration materials, which can be included in various filtration implements.

Of the invention, the fibrous material prepared by the formulations may consist of a substrate layer and a layer of nanofibers deposited on the substrate.

In certain cases, the formulation for preparing a fibrous material comprising nanofibers, comprising the following components:

(a) at least one polymer,

(b) at least one solvent in which the at least one polymer is dissolved to provide a polymer solution, and

(c) at least one functional additive that imparts functionality to the fibrous material, wherein the at least one functional additive comprises one or more selected from the following groups (c1) to (c3):
(c1) a biocide,
(c2) a processing aid,
(c3) a barrier for physical and/or chemical contaminants,

wherein components (a) to (c) add up in total to 100 wt. % of the formulation, and

wherein the at least one functional additive is dissolvable or suspensible in the polymer solution.

The formulation is advantageously formulated into the polymer solution which is used to produce the nanofibers through electrospinning of the formulations. The electrospinning of the formulation may be carried out in needle type or needleless type implements.

Components (c1), (c2) and (c3) may be present in the formulation individually or in any combination. In some cases, the formulation may comprise components (a), (b) and (c1). In some cases, the formulation may comprise components (a), (b) and (c2). In some cases, the formulation may comprise components (a), (b) and (c3). In some cases, the formulation may comprise components (a), (b), (c1) and (c2). In some cases, the formulation may comprise components (a), (b), (c1) and (c3). In some cases, the formulation may comprise components (a), (b), (c2) and (c3). In some cases, the formulation may comprise components (a), (b), (c1), (c2) and (c3).

The term “biocide” herein refers to a substance that can trap, kill or at least weaken infectious agents, including bacteria, virus and/or fungi upon contact to provide antimicrobial and antiviral functions. Examples of the infectious agents include S. aureus, E. coli, P. aeruginosa, Staphylococcus epidermidis, Staphylococcus haemolyticus, Klebsiella pneumoniae, drug-sensitive and drug-resistant bacteria, Candida albicans, influenza viruses, etc. According to the invention, the biocide includes anti-bacterial agents, anti-fungal agents, and anti-viral agents that are effect in fighting infections. Examples of the biocide may be selected from the group consisting of Povidone-iodine (PVP-I), Octenidine (OCT), Polybiguanides (e.g. Polyhexanide (PHMB), Polyaminopropyl Biguanide (PAPB)), Quaternary Ammonium Compounds (e.g. Ammonium Chloride, Benzalkonium Chloride, Benzododecinium Chloride, Benzethonium Chloride, Benzyltriethylammonium Chloride (BTEAC), Methylbenzethonium Chloride, Chlorhexidine (CHX) Salts, Cetylpyridinium Chloride, Cetalkonium Chloride, Cetrimonium Bromide (Cetyltrimethylammonium Salts), Cetrimide, Dofanium Chloride, Tetraethylammonium Bromide, Didecyldimethylammonium Chloride, Domiphen Bromide), Chloroxylenol, Silver Nanoparticle (Ag-NP), Silica Nanoparticle (Si-NP), Polyethyleneimines (PEI), N-Halamines, Zinc Citrate; Triclosan, Polyphenol (e.g. Catechin Polyphenols, Persimmon Tannin Polyphenols, Grape Seed Polyphenols, Soybean Polyphenols, Lemon Peel Polyphenols, Coffee Polyphenols, Coumarin), Phenylcarboxylic Acid, Ellagic Acid, and any combination thereof. Some natural compounds, e.g. mulberry bark, garcinia cowa roxb crude extract, may be also used as the biocide. By “any combination thereof”, it means that any two or more of the above compounds are simultaneously selected as the biocide for the formulation.

The term “processing aid” herein refers to a substance that acts as an agent to facilitate the antimicrobial ability of biocides or as a binder to enhance the binding of the functional additives and the polymer and/or the polymer solution. In one preferred embodiment of the invention, the processing aid is hydrophilic biocompatible polymers. The hydrophilic Biocompatible Polymers may be selected from the group consisting of Polyethylene Glycol (PEG), Poly(N-isopropylacrylamide), Polyacrylamide, Polyethylenimine, Poly(acrylic acid), Poly(vinyl alcohol) (PVA), Poly(vinylpyrrolidone), and any combination thereof. By “any combination thereof”, it means that any two or more of the above compounds are simultaneously selected as the polymer processing aid for the formulation.

The term “barrier for physical and/or chemical contaminants” herein refers to a substance that is capable of removing or reducing physical and/or chemical contaminants, such as heavy metals, chlorine, VOCs, and/or odor. For example, the barrier may be selected from aluminum hydroxide oxide (AlO(OH)) and/or Tourmaline for heavy metal removal; or from Tourmaline for chlorine removal; or Zeolite, Photocatalyst (e.g. TiO2) and/or Active Carbon for VOCs removal; or Zeolite and/or Active Carbon for odor removal. One or more barriers may be included in the formulation depending on the actual needs.

It would be appreciated that other additives may be added to the polymer solution to provide the polymer solution/the nanofibers with other functionalities, if desirable.

The polymer that may be used in the formulations of the invention includes polymers formed by hydrophobic monomer and/or hydrophilic monomer. Hydrophobic monomer may be selected from the group consisting of vinylidene fluoride, acrylonitrile, methacrylate, ethyl acrylate, methyl methacrylate, ethyl methacrylate, butyl methacrylate, vinyl acetate, vinyl pyrrolidone, vinylidene chloride, vinyl chloride, and any combination thereof. Hydrophilic monomer may be selected from the group consisting of acrylic acid, allyl alcohol, methallyl alcohol, hydroxyethyl acrylate, hydroxyethyl methacrylate, hydroxypropyl acrylate, butanediol monoacrylate, dimethylaminoethyl acrylate, butene tricarboxylic acid, ethylene glycol, N-isopropylacrylamide, acrylamide, ethylenimine, vinyl alcohol, vinylpyrrolidone, and any combination thereof.

The solvent that may be used in the formations of the invention includes organic and inorganic solvents, and includes but not limited to methanol, ethanol, isopropyl alcohol (IPA), acetone, tetrahydrofuran, methylene chloride, chloroform, dimethyl sulfoxide (DMSO), ethylene glycol, dimethylformamide (N, N-Dimethylformamide, DMF), dimethylacetamide (N, N-Dimethylacetamide, DMAc), N-Methyl-2-pyrrolidone (N-methyl pyrrolidone, NMP), cyclohexane, water, or any combination thereof.

For the illustrative purposes, exemplary formulations are discussed herein below.

An exemplary formulation useful for preparation of the polymer solution intended for air filtration has the following composition:

(a) 5-20 wt. % of at least one polymer,

(b) 55-95 wt. %, preferably 65-95 wt. % of at least one solvent in which the at least one polymer is dissolved to provide a polymer solution, and

(c) at least one functional additive that imparts functionality to the fibrous nanomaterial, wherein the at least one functional additive comprises one or more selected from the following groups (c1) to (c3):
(c1) 0.1-15 wt. %, preferably 0.1-10 wt. %, more preferably 0.1-5 wt. % of a biocide,
(c2) 0.1-5 wt. % of a processing aid, and
(c3) 0.1-5 wt. % of a barrier for physical and/or chemical contaminants,

wherein components (a), (b), (c1) to (c3) add up in total to 100 wt. % of the formulation, and

wherein each of the functional additive accounts for at least 0.1-5 wt. % if the formulation comprises two or more additives.

In a particular embodiment of the invention, a formulation useful for preparation of the polymer solution intended for air filtration has the following composition:

(a) 5-20 wt. % of PVDF,

(b) 55-95 wt. %, preferably 65-94.7 wt. % of DMF in which PVDF is dissolved to provide a polymer solution, and

(c1) a biocide comprising 0.1-10 wt. % of PVP-I, 0.1-5 wt. % of OCT, and 0.1-5 wt. % of BTEAC,

wherein components (a), (b) and (c1) add up in total to 100 wt. % of the formulation.

PVP-I and OCT have an excellent function in the antimicrobial and antiviral areas. Also, they have very mild or no irritation to the human skin, which are therefore good additives to applications like air filtration and textile or mattress cover.

An exemplary formulation useful for preparation of the polymer solution intended for water filtration has the following composition:

(a) 5-20 wt. % of at least one polymer,

(b) 55-94 wt. %, preferably 65-94 wt. % of at least one solvent in which the at least one polymer is dissolved to provide a polymer solution, and

(c) at least one functional additive that imparts functionality to the fibrous nanomaterial, wherein the at least one functional additive comprises one or more selected from the following groups (c1) to (c3):
(c1) 0.1-15 wt. %, preferably 0.1-10 wt. %, more preferably 0.1-5 wt. % of a biocide,
(c2) 0.1-5 wt. % of a processing aid, and
(c3) 0.1-5 wt. % of a barrier for physical and/or chemical contaminants,

wherein components (a), (b), (c1) to (c3) add up in total to 100 wt. % of the formulation, and

wherein each of the functional additive accounts for at least 0.1-5 wt. % if the formulation comprises two or more additives.

In a particular embodiment of the invention, the formulation useful for preparation of the polymer solution intended for water filtration has the following composition:

(a) 5-20 wt. % of PAN,

(b) 65-93.9 wt. % of DMF in which PVDF is dissolved to provide a polymer solution,

(c1) a biocide comprising 0.1-5 wt. % of BTEAC, and

(c3) a barrier for removal of heavy metals comprising 1-10 wt. % of aluminum hydroxide oxide (AlO(OH)),

wherein components (a), (b), (c1) and (c3) add up in total to 100 wt. % of the formulation.

BTEAC is an excellent disinfectant to kill bacteria, fungi and viruses while aluminum hydroxide oxide is insoluble to water, which can effectively apply in water filtration for killing microbes and removing heavy metal.

Generally, the viscosity of the polymer solution prepared by the formulation of the invention before the polymer solution is subject to the electrospinning is formulated in the range of 150-1800 mPa·s, preferably 200-1500 mPa·s, more preferably 300-1000 mPa·s. It has been found that the polymer solutions having the viscosity that is not within the above numerical ranges are not easy or would not properly form polymer electrospun fibers. Preferred formulations of the invention are listed in the following Table 1.

TABLE 1

| | | | Additive I | | | |
|---|---|---|---|---|---|---|
| Example | Polymer | Solvent | Component (c1) | Additive II | Additive III | Potential Applications |
| 1 | PVDF | DMF | PVP-I | | | Anti-bacterial, anti-fungal and |
| | | | | | | anti-viral Facemask, Air |
| | | | | | | Filtration, Textile & Mattress |
| 2 | PVDF | DMF | OCT | | | Anti-bacterial, anti-fungal and |
| | | | | | | anti-viral Facemask,Air |
| | | | | | | Filtration, Water Filtration, |
| | | | | | | Textile & Mattress Cover |
| 3 | PVDF | DMF | PVP-I | | | Anti-bacterial, anti-fungal and |
| | | | OCT | | | anti-viral Facemask, Air |
| | | | BTEAC | | | Filtration, Textile & Mattress |
| | | | | | | Cover |
| 4 | PVDF | DMF | Polybiguanides | | | Anti-bacterial, anti-fungal and |
| | | | | | | anti-viral Air Filtration & |
| | | | | | | Textile |
| 5 | PVDF | DMF | Quaternary | | | Anti-bacterial, anti-fungal and |
| | | | Ammonium | | | anti-viral Facemask, Air |
| | | | Compounds | | | Filtration, Textile & Mattress |
| | | | | | | Cover |
| 6 | PVDF | DMF | Chloroxylenol | | | Anti-bacterial, anti-fungal and |
| | | | | | | anti-viral Air Filtration & |
| | | | | | | Textile |
| 7 | PVDF | DMF | Si-NP | | | Anti-bacterial, anti-fungal and |
| | | | | | | anti-viral Air Filtration & |
| | | | | | | Textile |
| 8 | PVDF | DMF | Triclosan | | | Anti-bacterial and anti-fungal |
| | | | | | | Facemask, Air Filtration, |
| | | | | | | Textile & Mattress Cover |
| 9 | PVDF | DMF | Polyphenol | Component (c2) | | Anti-bacterial and anti-fungal |
| | | | Component (c1) | | | Facemask, Air Filtration, |
| | | | | | | Textile & Mattress Cover |
| 10 | PVDF | DMF | PVP-I | PEG | | Anti-bacterial, anti-fungal and |
| | | | | | | anti-viral Facemask, Air |
| | | | | | | Filtration, Textile & Mattress |
| | | | | | | Cover |
| 11 | PVDF | DMF | Polybiguanides | PEG | | Anti-bacterial, anti-fungal and |
| | | | Component (c1) | Component (c2) | | anti-viral Air Filtration & |
| | | | | | | Textile |
| 12 | PVDF | DMF | PVP-I | Zeolite | | Anti-bacterial, anti-fungal, |
| | | | | | | anti-viral, VOCs & odor |
| | | | | | | removal Air Filtration |
| 13 | PVDF | DMF | OCT | Tourmaline | | Anti-bacterial, anti-fungal, |
| | | | | | | anti-viral, heavy metal & |
| | | | | | | chlorine removal Water |
| | | | | | | Filtration |
| 14 | PAN | DMF | BTEAC | Aluminum | Component (c3) | Anti-bacterial, anti-fungal, |
| | | | Component (c1) | Hydroxide Oxide | | anti-viral, heavy metal |
| | | | | Component (c2) | | removal Air Filtration |
| 15 | PVDF | DMF | PVP-I | PEG | Zeolite | Anti-bacterial, anti-fungal, |
| | | | Component (c2) | | | anti-viral, VOCs & odor |
| | | | | | | removal Water Filtration |
| 16 | PVDF | DMF | PEG | Component (c1) | | Bacteria, fungi, virus filtering |
| | | | Component (c2) | | | Facemask, Air Filtration, |
| | | | | | | Textile & Mattress Cover |
| 17 | PVDF | DMF | PEG | PVP-I | | Anti-bacterial, anti-fungal and |
| | | | | | | anti-viral Facemask, Air |
| | | | | | | Filtration, Textile & Mattress |
| | | | | | | Cover |
| 18 | PVDF | DMF | PEG | Polybiguanides | | Anti-bacterial, anti-fungal and |
| | | | Component (c2) | Component (c3) | | anti-viral Air Filtration & |
| | | | | | | Textile |
| 19 | PVDF | DMF | PEG | Photocatalyst | | Anti-bacterial, anti-fungal and |
| | | | | | | anti-viral Facemask, Textile, |
| | | | | | | Air filtration |
| 20 | PVDF | DMF | PEG | Zeolite | Component (c3) | Anti-bacterial, anti-fungal and |
| | | | Component (c2) | Photocatalyst | | Zeolite anti-viral VOCs & odor |
| | | | | Component (c1) | | removal Air filtration |
| 21 | PVDF | DMF | PEG | PVP-I | Zeolite | Anti-bacterial, anti-fungal, |
| | | | Component (c3) | | | anti-viral, VOCs & odor |
| | | | | | | removal Air Filtration |
| 22 | PVDF | DMF | Photocatalyst | | | Anti-bacterial, anti-fungal and |
| | | | | | | anti-viral Facemask, Textile, |
| | | | | | | Air filtration |
| 23 | PVDF | DMF | Zeolite | | | Anti-bacterial, anti-fungal and |
| | | | Photocatalyst | | | anti-viral VOCs & odor |
| | | | | | | removal, Air filtration |
| 24 | PVDF | DMF | Tourmaline | Component (c1) | | Bacteria, fungi, virus filtering, |
| | | | Component (c3) | | | heavy metal & chlorine |
| | | | | | | removal, Water Filtration |
| 25 | PVDF | DMF | Zeolite | PVP-I | | Anti-bacterial, anti-fungal, |
| | | | | | | anti-viral, VOCs & odor |
| | | | | | | removal Air Filtration |
| 26 | PVDF | DMF | Tourmaline | OCT | | Anti-bacterial, anti-fungal, |
| | | | | | | anti-viral, heavy metal & |
| | | | | | | chlorine removal Water |
| | | | | | | Filtration |
| 27 | PAN | DMF | Aluminum | BTEAC | | Anti-bacterial, anti-fungal, |
| | | | Hydroxide Oxide | Component (c2) | | anti-viral, heavy metal |
| | | | Component (c3) | | | removal Water Filtration |
| 28 | PVDF | DMF | Photocatalyst | PEG | | Anti-bacterial, anti-fungal and |
| | | | | | | anti-viral Facemask, Textile, |
| | | | | | | Air filtration |
| 29 | PVDF | DMF | Zeolite | PEG | Component (c2) | Anti-bacterial, anti-fungal and |
| | | | Photocatalyst | Component (c1) | | anti-viral VOCs & odor |
| | | | Component (c3) | | | removal Air filtration |
| 30 | PVDF | DMF | Zeolite | PVP-I | PEG | Anti-bacterial, anti-fungal, |
| | | | | | | anti-viral, VOCs & odor |
| | | | | | | removal Air Filtration |

It would be appreciated that the present invention is not limited to above specific formulations.

The formulation of the invention is particularly adapted for electrospinning nanofibers onto a substrate to fabricate a fibrous material. In one aspect of the invention, a method for preparing a fibrous material comprising nanofibers, comprising the steps of:

a) providing a polymer solution formulated by the formulation of the invention,

b) providing one or more collection electrodes and one or more spinning electrodes between which a substrate passes through,

c) applying a voltage across the one or more collection electrodes and the one or more spinning electrodes to generate an electrostatic field which induces an electrospinning zone between the collection and spinning electrodes, and

d) supplying the polymer solution to the one or more spinning electrodes to be drawn into nanofibers from each of the spinning electrodes for deposition of the nanofibers onto the substrate to yield the fibrous material.

The method of invention may further comprise the step of applying a binder into the polymer solution in order for enhancement of the binding among the functional additives in the formulation, the polymer and the polymer solution before the polymer solution is supplied to the spinning electrodes. Alternatively, the binder may be provided in an aqueous dispersion which is applied to the substrate on which the nanofibers are deposited so as to help the binding between the electrospun polymer nanofibers deposited on the substrate and the functional additives in the polymer solution. More advantageously, an adhesive is applied on the substrate before entering the spinning zones to further enhance the adhesion between the substrate and the electrospun polymer nanofibers. One example of the adhesive is Akrylep 417E.

Optionally, the resulting substrate deposited with the nanofibers can be repeatedly entering the electrospinning apparatus (e.g. the apparatus of needless type) to allow for further deposition of the same/different fibers to increase the thickness and/or additional functions of the fiber layer, or fibers of different diameter and/or polymer identity to form two or more fiber layers. In some cases, two or more different formulations may be used to prepare two or more different polymer solutions respectively for electrospinning two or more layers of nanofibers depending on the actual needs for the fibers to be manufactured.

The substrate may be a flat and planar sheet, for example in the form of discrete sheets or continuous sheets. The substrate may include any porous knitted, woven and non-woven materials that may provide mechanical strength to support the one or more layers of nanofibers. It may comprise one or more polymer-based fibers selected from polypropylene, polyester, nylon, polyethylene, polyurethane, cellulose, polybutylene terephthalate, polyethylene terephthalate (PET), spunbonded polypropylene (PPSB), polycarbonate, polymethylpentene and/or polystyrene, and feasible polymers known in the art. In one preferred embodiment of the invention, the substrate is spunbonded polypropylene (PPSB). Generally, PPSB has an electric resistance at least of 10⁶Ω, for example in the range of 10⁶ to 10¹¹ Ω, preferably in the range of 10⁷ to 10¹⁰ Ω, to produce small and fine fiber diameters and prevent formation of fibers without no beads on the substrate.

During the needleless electrospinning process, the structure, thickness of fiber layer, density of deposition, and diameter of nanofibers may be varied by adjusting the following parameters, including the speed at which the substrate passes through the active spinning zones, the applied voltage between the spinning electrodes and the collection electrodes, the distance between the electrodes, as well as the composition of the polymer solution. The electrode distance is preferably adjusted between 20 cm-250 cm, more preferably between 30 cm-220 cm; the applied voltage is preferably maintained between −80 kV-100 kV, more preferably between −60 kV-90 kV; the temperature is preferably maintained between 5° C.-50° C., more preferably between 10° C.-40° C.; and the humidity is preferably maintained between 5%-70%, more preferably between 10%-60%.

Using the method of the invention, one or more layers of nanofibers having desirable diameters may be electronspun so that a gradient material comprising at least one type of nanofibers, and a material having interlaced structure of nanofibers and microfibers having different characteristics can be fabricated with a greater flexibility. Herein the “gradient” refers to the material's properties, for example density, pore size, fiber diameter, and so forth.

It is preferable to apply one or more layers of nanofibers on the substrate to suit different application scenarios. The nanofiber layer of fibrous material may vary in thickness, diameter, mean pore size and maximum pore size. The one or more layers of nanofibers manufactured from the formulation are functionalized to have various functions, e.g. germs killing ability, biocide properties, removal of heavy metals and odor, depending on the functional additives present in the formulation.

The fibrous material of the invention exhibits the excellent filterability, permeability and adsorption capability, light weight, and is therefore suitable to be used as a filter medium. The accordingly fabricated fibrous materials may find a wide range of applications, including but not limited to filtration materials and textiles. Notably, the fibrous material is an excellent alternative of air filtration material, polypropylene melt blown (PPMB) which has been widely used in making personal protection equipment encompassing respirators, face masks etc. in the art. A face mask having a filter medium made of the fibrous material of the invention is a subject matter of the invention.

In particular, the face mask comprises:

an outer protective layer exposed to an external environment,

an inner layer configured to fit for covering mouth and nose of a wearer, and

at least one intermediate layer comprising the filter medium and sandwiched between

the outer layer and the inner layer.

The face mask protects the wearers from inhalation of airborne pollutants, impurities, bacteria and viruses. Due to the presence of one or more layers of nanofibers in the filtration material of the intermediate layers, the face mask enables the comprehensive removal of a wide range of undesirable airborne particulates, chemicals, biological contaminants and other impurities to achieve a comprehensive depth filtration. The contaminants include but not limited to viruses, bacteria, dust, or allergic materials.

The outer layer and the inner layer of the face mask may be selected from the ones known in the art, and are preferably made of nonwoven material comprising one or more polymers selected form a group consisting of polyolefin (polypropylene, polyethylene, etc.), polyester, polyamide, polycarbonate, polystyrene, or mixtures thereof. The outer layer is fluid repelling and enables to block larger particles. The inner layer is moisture absorbing, and more preferably made of soft, comfortable to the wearer and/or hypoallergenic materials.

Preferably, the outer layer, intermediate filter layer, and/or inner layer change the hydrophilicity or hydrophobicity in a direction from the inner layer to the intermediate layer such that a moisture concentration gradient is formed between the inner layer and intermediate layer with the inner layer having the least moisture and the intermediate layer having the most moisture when the face mask is worn.

The filtration materials of the invention may also be used as a filter medium of a water filter adapted for portable and home water filtration systems, for example used in a drinking bottle. The water filter may be in the form of cylindrical filter or other configurations.

Thus, the invention provides a variety of formulations for preparing a fibrous material which may be functionalized according to the actual needs and requirement with ease. The fibrous material is advantageously useful as a filtration material or a filtration barrier. The invention makes it possible to electrospin various polymer solutions to obtain filter materials capable of removing or reducing various contaminants, including hard-to-remove heavy metals, bacteria and viruses, volatile organic compounds.

While the embodiments described herein are intended as exemplary formulations for fabricating fibrous materials and their production as well as the filters comprising the fibrous materials, it will be appreciated by those skilled in the art that the present invention is not limited to the embodiments illustrated. Those skilled in the art will envision many other possible variations and modifications by means of the skilled person's common knowledge without departing from the scope of the invention, however, such variations and modifications should fall into the scope of this invention.

What is claimed is:

1. A formulation for preparing a fibrous material comprising nanofibers, comprising the following components:
(a) at least one polymer,
(b) at least one solvent in which the at least one polymer is dissolved to provide a polymer solution, and
(c) at least one functional additive that imparts functionality to the fibrous material, wherein the at least one functional additive comprises one or more selected from the following groups (c1) to (c3):
(c1) a biocide,
(c2) a processing aid,
(c3) a barrier for physical and/or chemical contaminants,
wherein the at least one functional additive is dissolvable or suspensible in the polymer solution.

2. The formulation of claim 1, wherein components (a) to (c) add up in total to 100 wt. % of the formulation, and wherein components (c1), (c2) and (c3) are present in the formulation individually or in any combination.

3. The formulation of claim 1, wherein the biocide is selected from the group consisting of povidone-iodine (PVP-I), octenidine (OCT), polybiguanides, quaternary ammonium compounds, chloroxylenol, silver nanoparticle (Ag-NP), silica nanoparticle (Si-NP), polyethyleneimines (PEI), N-halamines, zinc citrate, triclosan, polyphenol, phenylcarboxylic acid, ellagic acid, and any combination thereof.

4. The formulation of claim 1, wherein the biocide is selected from the group consisting of polyhexanide (PHMB), polyaminopropyl biguanide (PAPB), ammonium chloride, benzalkonium chloride, benzododecinium chloride, benzethonium chloride, benzyltriethylammonium chloride (BTEAC), methylbenzethonium chloride, chlorhexidine salts, cetylpyridinium chloride, cetalkonium chloride, cetrimonium bromide, cetyltrimethylammonium salts, cetrimide, dofanium chloride, tetraethylammonium bromide, didecyldimethylammonium chloride, domiphen bromide, catechin polyphenols, persimmon tannin polyphenols, grape seed polyphenols, soybean polyphenols, lemon peel polyphenols, coffee polyphenols, and any combination thereof.

5. The formulation of claim 1, wherein the processing aid is hydrophilic biocompatible polymers preferably selected from the group consisting of polyethylene glycol (PEG), poly(N-isopropylacrylamide), polyacrylamide, polyethylenimine, poly(acrylic acid), poly(vinyl alcohol) (PVA), poly(vinylpyrrolidone), and any combination thereof.

6. The formulation of claim 1, wherein the barrier is selected from aluminum hydroxide oxide (AlO(OH)), tourmaline, tourmaline, Zeolite, photocatalyst, active carbon, and any combination thereof.

7. The formulation of claim 1, wherein the polymer includes polymers formed by hydrophobic monomer selected from the group consisting of vinylidene fluoride, acrylonitrile, methacrylate, ethyl acrylate, methyl methacrylate, ethyl methacrylate, butyl methacrylate, vinyl acetate, vinyl pyrrolidone, vinylidene chloride, vinyl chloride, and any combination thereof and/or hydrophilic monomer selected from the group consisting of acrylic acid, allyl alcohol, methallyl alcohol, hydroxyethyl acrylate, hydroxyethyl methacrylate, hydroxypropyl acrylate, butanediol monoacrylate, dimethylaminoethyl acrylate, butene tricarboxylic acid, ethylene glycol, N-isopropylacrylamide, acrylamide, ethylenimine, vinyl alcohol, vinylpyrrolidone, and any combination thereof.

8. The formulation of claim 1 for preparing the nanofibers useful for an air filter, comprising:
(a) 5-20 wt. % of the at least one polymer,
(b) 55-95 wt. %, preferably 65-95 wt. % of the at least one solvent,
(c1) 0.1-15 wt. %, preferably 0.1-10 wt. %, more preferably 0.1-5 wt. % of the biocide,
(c2) 0.1-5 wt. % of the processing aid, and
(c3) 0.1-5 wt. % of the barrier,
wherein components (a), (b), (c1) to (c3) add up in total to 100 wt. % of the formulation, and
wherein each of the functional additives (c1), (c2) and (c3) accounts for at least 0.1-5 wt. % if the formulation comprises two or more additives.

9. The formulation of claim 8, comprising:
(a) 5-20 wt. % of PVDF,
(b) 55-95 wt. %, preferably 65-94.7 wt. % of DMF in which PVDF is dissolved to provide the polymer solution, and
(c1) the biocide comprising 0.1-10 wt. % of PVP-I, 0.1-5 wt. % of OCT, and 0.1-5 wt. % of BTEAC,
wherein components (a), (b) and (c1) add up in total to 100 wt. % of the formulation.

10. The formulation of claim 1 for preparing the nanofibers useful for a water filter, comprising:
(a) 5-20 wt. % of the at least one polymer,
(b) 55-94 wt. %, preferably 65-94 wt. % of the at least one solvent, and
(c1) 0.1-15 wt. %, preferably 0.1-10 wt. %, more preferably 0.1-5 wt. % of the biocide,
(c2) 0.1-5 wt. % of the processing aid, and
(c3) 0.1-5 wt. % of the barrier,
wherein components (a), (b), (c1) to (c3) add up in total to 100 wt. % of the formulation, and
wherein each of the functional additives (c1), (c2) and (c3) accounts for at least 0.1-5 wt. % if the formulation comprises two or more additives.

11. The formulation of claim 10, comprising:
(a) 5-20 wt. % of PAN,
(b) 65-93.9 wt. % of DMF in which PAN is dissolved to provide the polymer solution,
(c1) the biocide comprising 0.1-5 wt. % of BTEAC, and
(c3) the barrier for removal of heavy metals comprising 1-10 wt. % of aluminum hydroxide oxide,
wherein components (a), (b), (c1) and (c3) add up in total to 100 wt. % of the formulation.

12. The formulation of claim 1, selected from Table 1.

13. A filter comprising a fibrous material used as the material of a filter medium of the filter, wherein the fibrous material is prepared by the formulation of claim 1.

14. The filter of claim 13, wherein the filter is the type of face mask comprising:
an outer protective layer exposed to an external environment,
an inner layer configured to fit for covering mouth and nose of a wearer, and
at least one intermediate layer comprising the filter medium and sandwiched between the outer layer and the inner layer.

15. The filter of claim 14, wherein the outer layer, intermediate filter layer, and/or inner layer vary hydrophilicity or hydrophobicity in a direction from the inner layer to the intermediate layer such that a moisture concentration gradient is formed between the inner layer and intermediate layer with the inner layer having the least moisture and the intermediate layer having the most moisture when the face mask is worn.

16. The filter of claim 13, wherein the filter is the type of water filter adapted for portable and home water filtration systems.

17. A method of producing a fibrous material comprising nanofibers, comprising the steps of:
a) providing a polymer solution formulated by the formulation according to claim 1,
b) providing one or more collection electrodes and one or more spinning electrodes between which a substrate passes through,
c) applying a voltage across the one or more collection electrodes and the one or more spinning electrodes to generate an electrostatic field which induces an electrospinning zone between the collection and spinning electrodes, and
d) supplying the polymer solution to the one or more spinning electrodes to be drawn into nanofibers from each of the spinning electrodes for deposition of the nanofibers onto the substrate.

18. The method of claim 17, further comprise the step of applying a binder into the polymer solution before the polymer solution is supplied to the spinning electrodes, or applying a binder in a form of aqueous dispersion onto the substrate on which the nanofibers are deposited.

19. The method of claim 17, comprising the step of interlacing the nanofibers to form a fiber layer with an interlaced structure.

20. A fibrous material comprising:
a substrate,
one or more layers of nanofibers applied on the substrate,
wherein the nanofibers are fabricated from the formulation of claim 1.
